(19) United States
(12) Patent Application Publication
(10) Pub. No.: US 2007/0262645 A1
(43) Pub. Date: Nov. 15, 2007

(54) Power supply control with current surge balance control

(75) Inventors: Edward A. Burton, Hillsboro, OR (US); Robert Greiner, Beaverton, OR (US); Anant Deval, Beaverton, OR (US); Doug Huard, Portland, OR (US); Stephen H. Gunther, Beaverton, OR (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/434,423

(22) Filed: May 12, 2006

(51) Int. Cl. H02J 1/00

(52) U.S. Cl. 307/36

(57) ABSTRACT

For one disclosed embodiment, modulation circuitry may control power conversion circuitry to supply power for one or more load circuits. Voltage regulation control circuitry may control the modulation circuitry to regulate voltage supply from the power conversion circuitry. Current surge balance control circuitry may separately control the modulation circuitry to provide supply current steps by the power conversion circuitry to help cancel load current surges. Other embodiments are also disclosed.

### FIELD

Embodiments described herein generally relate to supply of power for load circuit(s).

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, a block diagram of a system having power supply control with current surge balance control;

FIG. 2 illustrates, for one embodiment, a flow diagram to control supply of power with current surge balance control;

FIG. 3 illustrates, for one embodiment, example circuitry for power control circuitry and power conversion circuitry of FIG. 1;

FIG. 4 illustrates, for one embodiment, an example signal timing diagram for circuitry of FIG. 3;

FIG. 5 illustrates, for one embodiment, a flow diagram to provide a supply current step;

FIG. 6 illustrates, for one embodiment, a flow diagram to provide a supply current step; and

FIG. 7 illustrates, for one embodiment, a block diagram of an example system comprising a processor having circuitry to control supply of power for the processor with current surge balance control.

The figures of the drawings are not necessarily drawn to scale.

### DETAILED DESCRIPTION

The following detailed description sets forth example embodiments of apparatuses, methods, and systems relating to power supply control with current surge balance control. Features, such as structure(s), function(s), and/or characteristic(s) for example, are described with reference to one embodiment as a matter of convenience; various embodiments may be implemented with any suitable one or more described features.

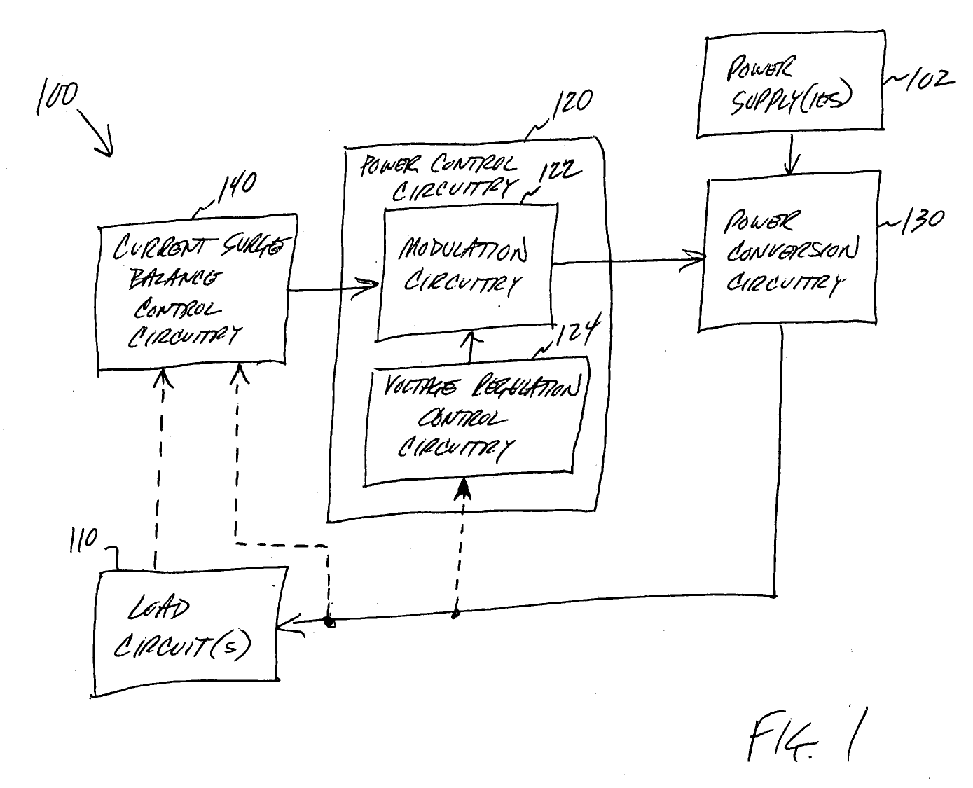

FIG. 1 illustrates, for one embodiment, a system 100 comprising one or more load circuits 110, power control circuitry 120 to control power conversion circuitry 130 to supply power for load circuit(s) 110, and current surge balance control circuitry 140 to help control power conversion circuitry 130 to provide supply current steps. Current surge balance control circuitry 140 for one embodiment may help control power conversion circuitry 130 to provide supply current steps to help cancel load current surges. Current surge balance control circuitry 140 may comprise any suitable circuitry to help control power conversion circuitry 130 to provide supply current steps in any suitable manner.

System 100 for one embodiment may comprise one or more power supplies 102. Power conversion circuitry 130 may be coupled to receive power from one or more power supplies 102 to supply power for load circuit(s) 110. Power conversion circuitry 130 may include any suitable circuitry to help supply power to load circuit(s) 110 in any suitable manner. Power supply(ies) 102 for one embodiment may include a battery. Power supply(ies) 102 for one embodiment may include an alternating current to direct current (AC-DC) converter. Power supply(ies) 102 for one embodiment may include a fuel cell or super capacitor.

Load circuit(s) 110, power control circuitry 120, and current surge balance control circuitry 140 for one embodiment may be on an integrated circuit, and power conversion circuitry 130 for one embodiment may be external to such an integrated circuit. Power conversion circuitry 130 for one embodiment may be coupled to supply power to such an integrated circuit.

Power control circuitry 120 may include any suitable circuitry coupled to control power conversion circuitry 130 in any suitable manner. Power control circuitry 120 for one embodiment, as illustrated in FIG. 1, may include modulation circuitry 122 and voltage regulation control circuitry 124.

Modulation circuitry 122 may be coupled to control power conversion circuitry 130 to supply power for load circuit(s) 110. Modulation circuitry 122 may include any suitable circuitry to control power conversion circuitry 130 in any suitable manner. Modulation circuitry 122 for one embodiment may include, for example, a pulse width modulator or a pulse frequency modulator.

Voltage regulation control circuitry 124 may be coupled to control modulation circuitry 122 to regulate voltage supply from power conversion circuitry 130. Voltage regulation control circuitry 124 may include any suitable circuitry to control modulation circuitry 122 in any suitable manner. Voltage regulation control circuitry 124 for one embodiment may control modulation circuitry 122 in accordance with a closed loop control function.

Current surge balance control circuitry 140 for one embodiment may be coupled to control modulation circuitry 122 to provide supply current steps by power conversion circuitry 130. Current surge balance control circuitry 140 may include any suitable circuitry to control modulation circuitry 122 in any suitable manner. Current surge balance control circuitry 140 for one embodiment may be coupled to control modulation circuitry 122 separately from voltage regulation control circuitry 124.

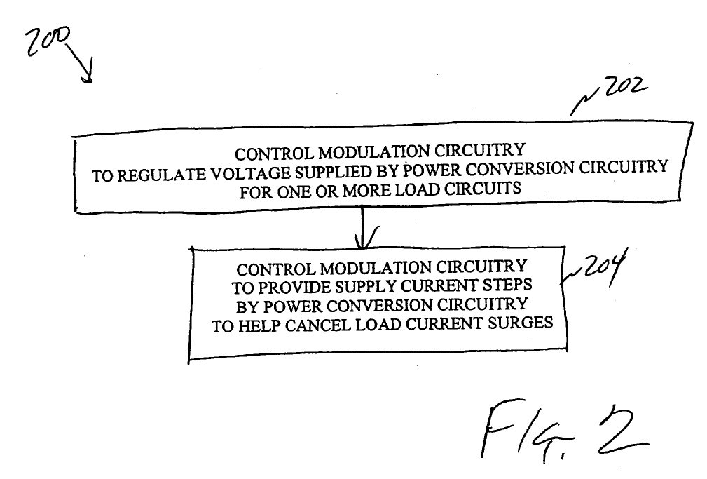

Voltage regulation control circuitry 124 and current surge balance control circuitry 140 for one embodiment may help control power conversion circuitry 130 to supply power for load circuit(s) 110 in accordance with a flow diagram 200 of FIG. 2.

For block 202 of FIG. 2, voltage regulation control circuitry 124 may control modulation circuitry 122 to regulate voltage supplied by power conversion circuitry 130 for load circuit(s) 110. For block 204, current surge balance control circuitry 140 may control modulation circuitry 122 to provide supply current steps by power conversion circuitry 130 to help cancel load current surges.

Voltage regulation control circuitry 124 and current surge balance control circuitry 140 for one embodiment may repeat operations for blocks 202-204.

Voltage regulation control circuitry 124 and current surge balance control circuitry 140 may perform operations for blocks 202-204 in any suitable order and may or may not overlap in time the performance of any suitable operation with any other suitable operation.

Current surge balance control circuitry 140 for one embodiment, as illustrated in FIG. 1, may optionally be coupled to monitor load current of the power supply from power conversion circuitry 130 to help control provision of supply current steps based at least in part on the monitored load current.

Current surge balance control circuitry 140 for one embodiment, as illustrated in FIG. 1, may optionally be coupled to receive one or more signals regarding activity by load circuit(s) 110. Current surge balance control circuitry 140 for one embodiment may control modulation circuitry 122 to provide a supply current step in response to such signal(s). Current surge balance control circuitry 140 for one embodiment may receive one or more signals regarding activity by load circuit(s) 110 to anticipate a load current surge.

Supply of Power for Load Circuit(s)

Power control circuitry 120 and power conversion circuitry 130 for one embodiment may include any suitable circuitry to implement any suitable voltage regulator. Power control circuitry 120 and power conversion circuitry 130 for one embodiment may include any suitable circuitry to implement a suitable closed-loop feedback voltage regulator. Power control circuitry 120 for one embodiment may monitor a voltage of the power supply from power conversion circuitry 130 and control power conversion circuitry 130 to supply power based at least in part on the monitored voltage. Power control circuitry 120 for one embodiment may control power conversion circuitry 130 to supply power based at least in part on the monitored voltage relative to a reference or target voltage. Power control circuitry 120 for one embodiment may control power conversion circuitry 130 to help supply and maintain a relatively steady voltage relative to a reference voltage. Power control circuitry 120 for one embodiment may control power conversion circuitry 130 to help supply and maintain a voltage substantially equal to a reference or target voltage.

Power control circuitry 120 and power conversion circuitry 130 for one embodiment may include any suitable circuitry to implement any suitable multiphase switching voltage regulator. Power control circuitry 120 for one embodiment may generate multiple phased control signals over multiple lines to control power conversion circuitry 130. Power control circuitry 120 for one embodiment may generate multiple pulsed phased control signals to control power conversion circuitry 130.

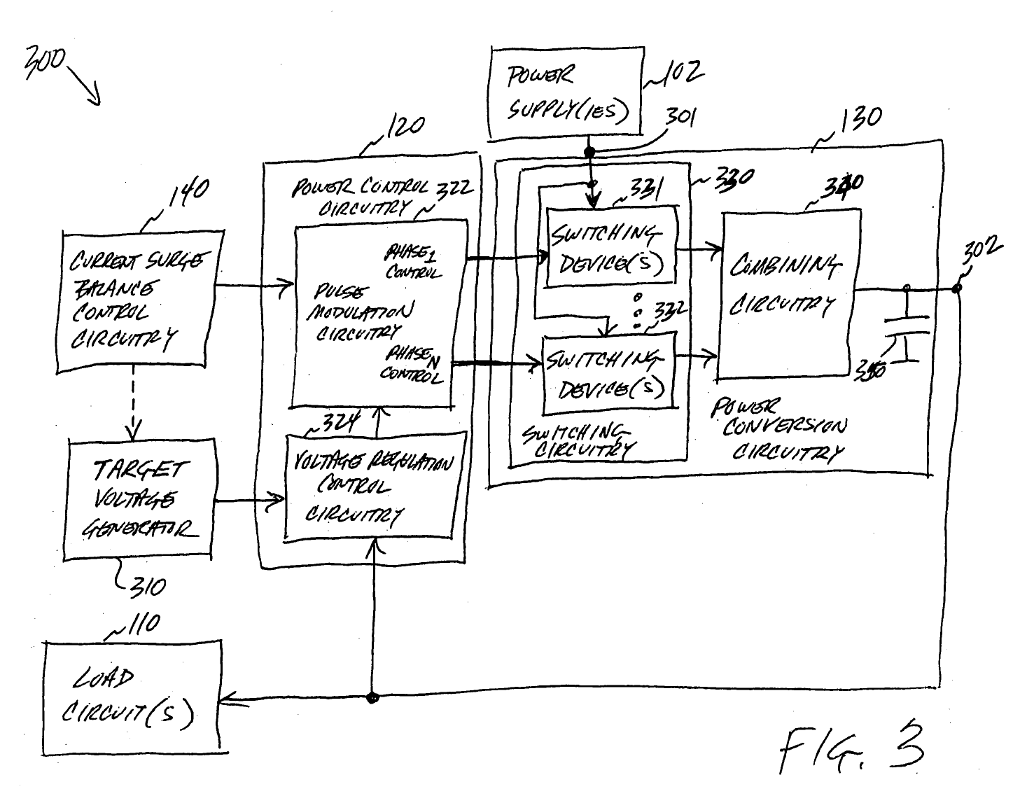

Power control circuitry 120 and power conversion circuitry 130 for one embodiment may include suitable circuitry to implement a voltage regulator as illustrated in a system 300 of FIG. 3. Power conversion circuitry 130 for one embodiment, as illustrated in FIG. 3, may be coupled to receive from power supply(ies) 102 an input supply voltage signal at a supply node 301 and supply a regulated output supply voltage signal at an output node 302.

Power control circuitry 120 for one embodiment, as illustrated in FIG. 3, may include pulse modulation circuitry 322 to generate multiple pulsed phased control signals to control power conversion circuitry 130. Pulse modulation circuitry 322 may generally correspond to modulation circuitry 122 of FIG. 1. Pulse modulation circuitry 322 may generate any suitable number of control signals having any suitable number of phases. Pulse modulation circuitry 322 for one embodiment may generate any suitable number of one or more control signals corresponding to each of N phases, where N is an integer greater than one.

Pulse modulation circuitry 322 for one embodiment may generate control signals having any suitable phase relationship relative to one another and/or to one or more reference signals. Pulse modulation circuitry 322 for one embodiment may generate control signals having a substantially 360/N degree phase relationship relative to one or more other control signals and/or to one or more reference signals. As one example where N is equal to five, pulse modulation circuitry 322 for one embodiment may generate one or more control signals having a substantially 72 degree phase relationship relative to one or more other control signals.

Pulse modulation circuitry 322 for one embodiment, as illustrated in FIG. 3, may generate and output phased control signals over multiple lines to control power conversion circuitry 130. Such multiple lines for one embodiment may correspond to N phases. That is, pulse modulation circuitry 322 for one embodiment may output over one line one or more control signals corresponding to one of N phases.

Pulse modulation circuitry 322 may generate any suitable phased control signals to help control the voltage at output node 302. Pulse modulation circuitry 322 for one embodiment may generate pulsed phased control signals and control a pulse duration and/or a duty cycle of such control signals to help control the voltage at output node 302. Pulse modulation circuitry 322 may generate such pulsed phased control signals with a pulse of any suitable shape. Pulse modulation circuitry 322 for one embodiment may include any suitable pulse width modulation circuitry.

Power control circuitry 120 for one embodiment, as illustrated in FIG. 3, may include voltage regulation control circuitry 324 coupled to control pulse modulation circuitry 322 and coupled to monitor the voltage at output node 302 to help control phased control signals. Voltage regulation control circuitry 324 may generally correspond to voltage regulation control circuitry 124 of FIG. 1. Voltage regulation control circuitry 324 for one embodiment may compare a voltage corresponding to the voltage at output node 302 and a voltage corresponding to a reference or target voltage to sense error in the voltage at output node 302. Voltage regulation control circuitry 324 may then help control phased control signals in response to the sensed error.

Voltage regulation control circuitry 324 for one embodiment may be coupled to receive a voltage signal corresponding to the voltage at output node 302 and a reference voltage signal corresponding to a reference or target voltage. Power control circuitry 120 may be coupled to receive the output supply voltage signal at output node 302 or a voltage signal derived from the output supply voltage signal at output node 302. Power control circuitry 120 for one embodiment, as illustrated in FIG. 3, may be coupled to receive a target voltage signal from a target voltage generator 310.

Power conversion circuitry 130 for one embodiment, as illustrated in FIG. 3, may include switching circuitry 330 to generate pulsed signals in response to phased control signals generated from pulse modulation circuitry 322. Switching circuitry 330 for one embodiment may be coupled to receive phased control signals from pulse modulation circuitry 322. Switching circuitry 330 may include any suitable circuitry to generate any suitable number of any suitable pulsed signals in any suitable manner in response to phased control signals.

Switching circuitry 330 for one embodiment may be coupled to supply node 301 to receive the input supply voltage signal from power supply(ies) 102. Switching circuitry 330 for one embodiment may generate pulsed signals having an amplitude corresponding to the input supply voltage signal at supply node 301.

Switching circuitry 330 may generate any suitable pulsed signals having any suitable pulse shape to help control the output supply voltage signal at output node 302. Switching circuitry 330 for one embodiment may generate pulsed signals having a pulse width and/or duty cycle based on phased control signals from pulse modulation circuitry 322.

Switching circuitry 330 for one embodiment, as illustrated in FIG. 3, may include switching devices corresponding to N phases of control signals generated by pulse modulation circuitry 322. Switching circuitry 330 may include, for example, one or more switching devices 331 corresponding to a first phase and one or more switching devices 332 corresponding to an Nth phase. One or more switching devices for one embodiment may be coupled to receive one or more control signals corresponding to one of the N phases to generate any suitable number of one or more pulsed signals corresponding to that one phase. One or more switching devices for one embodiment may generate multiple pulsed signals having substantially the same phase. One or more switching devices for one embodiment may include, for example, one or more power transistors.

Power conversion circuitry 130 for one embodiment may include combining circuitry 340 to generate output pulsed signals at output node 302 in response to pulsed signals generated from switching circuitry 330. Combining circuitry 340 for one embodiment may be coupled to receive pulsed signals from switching circuitry 330. Combining circuitry 340 may include any suitable circuitry to generate output pulsed signals at output node 302 in any suitable manner in response to pulsed signals. Combining circuitry 340 for one embodiment may include, for example, passive components such as inductors and/or coupled inductors for example. Combining circuitry 340 for one embodiment may combine received pulsed signals in any suitable manner to generate output pulsed signals at output node 302.

Power conversion circuitry 130 for one embodiment may include any suitable one or more energy storing devices coupled to output node 302 to receive and store energy from output pulsed signals at output node 302. Power conversion circuitry 130 for one embodiment may include one or more capacitors, collectively represented by an output capacitor 350 in FIG. 3, coupled between output node 302 and a reference supply node, such as ground for example.

One or more of load circuit(s) 110 may draw energy from such energy storing device(s) as such energy storing device(s) receive and store energy from output pulsed signals. Such energy storing device(s) for one embodiment may help maintain the output supply voltage signal at output node 302 as one or more load circuit(s) 110 draw varying amounts of current.

Because power control circuitry 120 for one embodiment may be coupled to monitor voltage at output node 302, power control circuitry 120 and power conversion circuitry 130 for one embodiment may define a closed feedback loop to monitor the output supply voltage signal to help control phased control signals as power conversion circuitry 130 generates the output supply voltage signal. Power control circuitry 120 may monitor the output supply voltage signal and/or control phased control signals in response to such monitoring in accordance with any suitable scheme such as, for example, substantially continuously, discretely at any suitable rate, or in response to any suitable event.

Providing Supply Current Step in Power Supply

Current surge balance control circuitry 140 may include any suitable circuitry to control power control circuitry 120 to help control power conversion circuitry 130 to provide supply current steps in any suitable manner. Current surge balance control circuitry 140 for one embodiment may control modulation circuitry 122 of power control circuitry 120 to help control power conversion circuitry 130 to provide supply current steps.

Current surge balance control circuitry 140 for one embodiment may generate one or more supply current step request signals to request power control circuitry 120 to help provide a supply current step. Current surge balance control circuitry 140 for one embodiment may generate a pulsed supply current step request signal to request power control circuitry 120 to help provide a supply current step.

Power control circuitry 120 for one embodiment may control power conversion circuitry 130 to provide a supply current step having substantially a predetermined size. Power control circuitry 120 for one embodiment may control power conversion circuitry 130 to provide a supply current step having a variable or programmable size. Power control circuitry 120 for one embodiment may control power conversion circuitry 130 to provide a supply current step having substantially a desired size based at least in part on a request from current surge balance control circuitry 140.

Power control circuitry 120 for one embodiment may generate one or more supply current step control signals to control power conversion circuitry 130 to provide a supply current step in response to one or more supply current step request signals. Power control circuitry 120 for one embodiment may generate one or more pulsed supply current step control signals. Power control circuitry 120 for one embodiment may generate one or more pulsed supply current step control signals and control a pulse duration and/or a duty cycle of such control signals to help control a supply current step to be provided by power conversion circuitry 130.

For one embodiment where power control circuitry 120 controls power conversion circuitry 130 to implement a multiphase switching voltage regulator, such as in one embodiment illustrated in FIG. 3 for example, power control circuitry 120 for one embodiment may generate multiple phased control signals over multiple lines to control power conversion circuitry 130 to supply power for load circuit(s) 110. Current surge balance control circuitry 140 may request power control circuitry 120 to generate one or more supply current step control signals over one or more of the multiple lines to control power conversion circuitry 130 to provide a supply current step.

Power control circuitry 120 for one embodiment, as illustrated in FIG. 3, may include pulse modulation circuitry 322 to generate multiple pulsed phased control signals over multiple lines and one or more supply current step control signals over one or more of the multiple lines. Pulse modulation circuitry 322 for one embodiment may generate pulsed phased control signals in accordance with any suitable schedule, such as a round robin schedule for example, as to over which line a pulsed phased control signal is to be generated. Pulse modulation circuitry 322 may generate one or more pulsed supply current step control signals over a line over which power control circuitry 120 generates one or more pulsed phased control signals in any suitable manner. Pulse modulation circuitry 322 for one embodiment may generate one or more pulsed supply current step control signals in accordance with any suitable schedule, such as a round robin schedule for example, as to over which line a pulsed supply current step control signal is to be generated.

Pulse modulation circuitry 322 for one embodiment may help reduce or avoid overlap in generating a pulsed supply current step control signal and a pulsed phased control signal over the same line. Pulse modulation circuitry 322 for one embodiment may generate a pulsed supply current step control signal to be separate from a pulsed phased control signal on the same line. Pulse modulation circuitry 322 for one embodiment may concatenate a pulsed supply current step control signal with a pulsed phased control signal on the same line. Power control circuitry 120 for one embodiment may extend a pulse width of a pulsed phased control signal to effectively concatenate a pulsed supply current step control signal with the pulsed phased control signal. Pulse modulation circuitry 322 for one embodiment may also help reduce or avoid overlap in generating a pulsed supply current step control signal and another pulsed supply current step control signal over the same line.

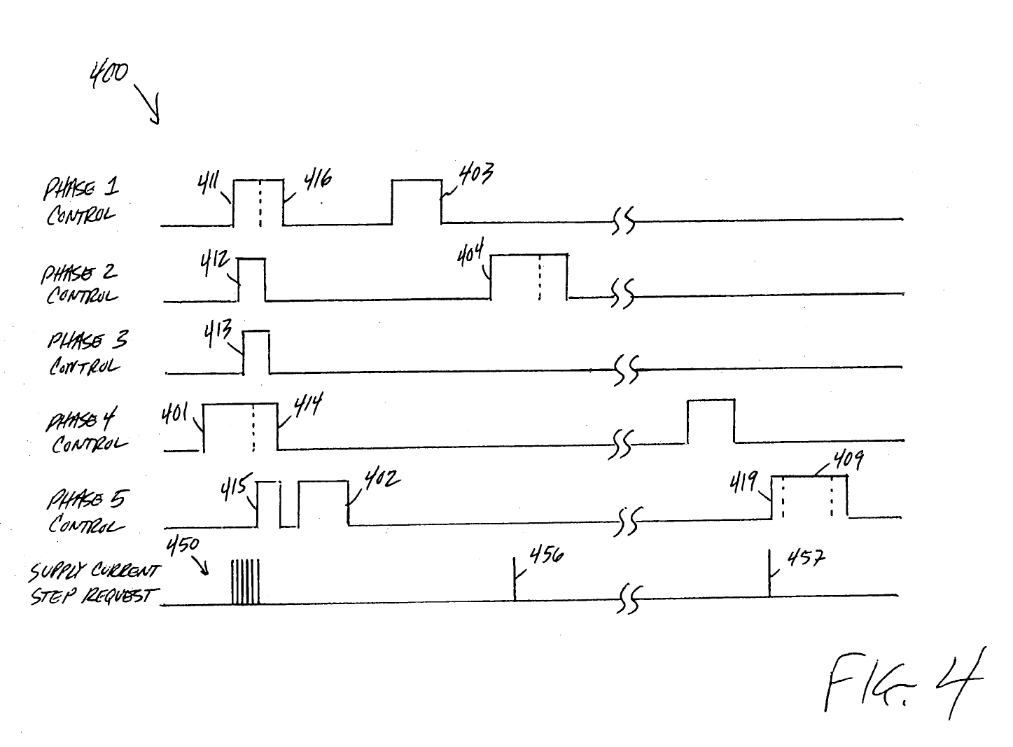

FIG. 4 illustrates, for one embodiment, an example signal timing diagram 400 for power control circuitry 120 and current surge balance control circuitry 140 of FIG. 3.

As illustrated in FIG. 4, pulse modulation circuitry 322 may generate pulsed phased control signals over five lines corresponding to five respective phases. FIG. 4 illustrates, for example, a pulsed phased control signal 401 over a line for a fourth phase, a pulsed phase control signal 402 over a line for a fifth phase, a pulsed phase control signal 403 over a line for a first phase, a pulsed phase control signal 404 over a line for a second phase, etc. Pulsed phased control signals 401-404 for one embodiment may have a substantially 72 degree phase relationship relative to a prior generated pulsed phased control signal.

Current surge balance control circuitry 140 for one embodiment may generate a pulsed supply current step request signal, such as pulsed supply current step request signal 456 for example, to request pulse modulation circuitry 322 to help provide a supply current step.

Current surge balance control circuitry 140 may generate, for example, six pulsed supply current step request signals 450 in rapid succession. Pulse modulation circuitry 322 may then respectively generate, for example, a pulsed supply current step control signal 411 over the first phase line, a pulsed supply current step control signal 412 over the second phase line, a pulsed supply current step control signal 413 over the third phase line, a pulsed supply current step control signal 414 over the fourth phase line, a pulsed supply current step control signal 415 over the fifth phase line, and a pulsed supply current step control signal 416 over the first phase line.

As illustrated in FIG. 4, pulsed supply current step control signal 414 would have overlapped the trailing edge of pulsed phased control signal 401 so pulse modulation circuitry 322 extended the trailing edge of pulsed phased control signal 401 to concatenate pulsed supply current step control signal 414 to pulsed phased control signal 401. Also, pulsed supply current step control signal 416 would have overlapped the trailing edge of pulsed supply current step control signal 411 so pulse modulation circuitry 322 extended the trailing edge of pulsed supply current step control signal 411 to concatenate pulsed supply current step control signal 416 to pulsed supply current step control signal 411.

Current surge balance control circuitry 140 may also generate, for example, a pulsed supply current step request signal 457 to generate a pulsed supply current step control signal 419 that would have overlapped the leading edge of a pulsed phased control signal 409 so pulse modulation circuitry 322 extended the trailing edge of pulsed supply current step control signal 419 to concatenate pulsed phased control signal 409 to pulsed supply current step control signal 419.

Current Supply Step for Monitored Load Current Surge

Current surge balance control circuitry 140 for one embodiment may include any suitable circuitry to help control power conversion circuitry 130 to provide a supply current step in any suitable manner based at least in part on a monitored load current of the power supply from power conversion circuitry 130.

Current surge balance control circuitry 140 for one embodiment may monitor current in the power supply from power conversion circuitry 130, may identify whether any suitable one or more relationships in connection with the monitored current are satisfied, and may help control power conversion circuitry 130 to provide a supply current step when one or more relationships are satisfied.

Current surge balance control circuitry 140 for one embodiment may help provide a supply current step based at least in part on whether the monitored current has increased. Current surge balance control circuitry 140 for one embodiment may help provide a supply current step based at least in part on an amount of monitored current relative to a predetermined current step amount. Current surge balance control circuitry 140 for one embodiment may accumulate current steps corresponding to current supply steps provided by power conversion circuitry 130 to help account for the additional current provided to load circuit(s) 110 and may help control provision of supply current steps based at least in part on such accumulated current steps. Current surge balance control circuitry 140 for one embodiment may help provide a supply current step based at least in part on an amount of monitored current relative to such accumulated current steps. Current surge balance control circuitry 140 for one embodiment may decrease such accumulated current steps over time to help account for power control circuitry 120 compensating for provided supply current steps.

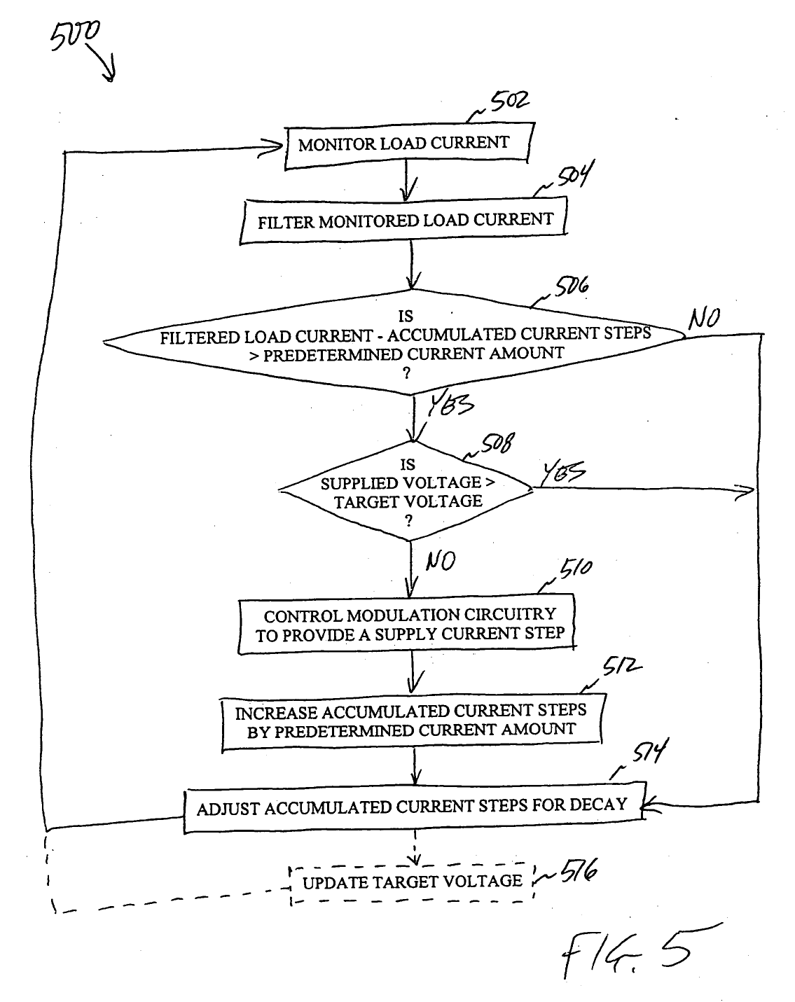

Current surge balance control circuitry 140 for one embodiment may help control power conversion circuitry 130 to provide a supply current step based at least in part on monitored current in accordance with a flow diagram 500 of FIG. 5.

For block 502 of FIG. 5, current surge balance control circuitry 140 may monitor load current in power from power conversion circuitry 130. Current surge balance control circuitry 140 for one embodiment for block 504 may filter monitored load current to help identify a load current surge. Current surge balance control circuitry 140 for one embodiment for block 504 may, for example, high pass filter or bandpass filter monitored load current.

For block 506, current surge balance control circuitry 140 may identify whether filtered load current satisfies one or more relationships based at least in part on a predetermined current step amount and/or an accumulated current step amount. Current surge balance control circuitry 140 for one embodiment for block 506 may identify whether filtered load current has increased by at least a predetermined current step amount. Current surge balance control circuitry 140 for one embodiment for block 506, as illustrated in FIG. 5, may identify whether the difference between a filtered load current and a filtered accumulation of current steps is greater than, or alternatively greater than or equal to, a predetermined current step amount.

For block 508, current surge balance control circuitry 140 for one embodiment may identify whether voltage supply by power conversion circuitry 130 is greater than, or alternatively greater than or equal to, a target voltage.

If current surge balance control circuitry 140 for one embodiment may identify that filtered load current satisfies one or more relationships for block 506 and/or that voltage supply by power conversion circuitry 130 is, for example, not greater than a target voltage for block 508, then current surge balance control circuitry 140 for block 510 may help control power conversion circuitry 130 to provide a supply current step. Current surge balance control circuitry 140 for one embodiment for block 510 may help control power conversion circuitry 130 to provide a supply current step of the predetermined current step amount for block 506.

Current surge balance control circuitry 140 for one embodiment may inhibit provision of a supply current step if voltage supply by power conversion circuitry 130, for example, exceeds a target voltage.

For block 512, current surge balance control circuitry 140 may increase the accumulated current step amount to help account for the increased current supplied to load circuit(s) 110. Current surge balance control circuitry 140 for one embodiment may increase the accumulated current step amount by the predetermined current step amount for block 506.

For block 514, current surge balance control circuitry 140 for one embodiment may adjust the accumulated current step amount for decay of the accumulated current step amount. Current surge balance control circuitry 140 for one embodiment may scale the accumulated current step amount by any suitable decay scaler. Current surge balance control circuitry 140 for one embodiment may adjust the accumulated current step amount for decay regardless of whether current surge balance control circuitry 140 helps control power conversion circuitry 130 to provide a supply current step. In this manner, current surge balance control circuitry 140 may adjust the accumulated current step amount to decay over time.

For block 516, current surge balance control circuitry 140 for one embodiment may optionally update a target voltage for power control circuitry 120, such as for one embodiment for power control circuitry 120 illustrated in FIG. 3 for example. Current surge balance control circuitry 140 for one embodiment may update a target voltage generally in proportion to the accumulated current step amount, for example, to help account cyclic loads.

Current surge balance control circuitry 140 for one embodiment may repeat operations for flow diagram 500. Current surge balance control circuitry 140 may perform operations for blocks 502-516 in any suitable order and may or may not overlap in time the performance of any suitable operation with any other suitable operation.

Current surge balance control circuitry 140 for one embodiment may comprise, for example, any suitable digital circuitry to help perform operations for flow diagram 500. Current surge balance control circuitry 140 for one embodiment may comprise, for example, control logic, such as a microcontroller for example, to perform instructions to help perform operations for flow diagram 500.

Current Supply Step for Load Activity

Current surge balance control circuitry 140 for one embodiment may include any suitable circuitry to help control power conversion circuitry 130 to provide a supply current step in any suitable manner based on activity by load circuit(s) 110. Such activity may include, for example, one or more events that have occurred, are occurring, and/or will occur in load circuit(s) 110.

Current surge balance control circuitry 140 for one embodiment may help provide a supply current step in response to one or more signals regarding activity by load circuit(s) 110. Current surge balance control circuitry 140 for one embodiment may help provide a supply current step in anticipation of a load current surge. Current surge balance control circuitry 140 for one embodiment may help provide a supply current step in anticipation of activation of a load circuit. Current surge balance control circuitry 140 for one embodiment may help provide a supply current step based at least in part on an estimated load current for one or more activities by load circuit(s) 110.

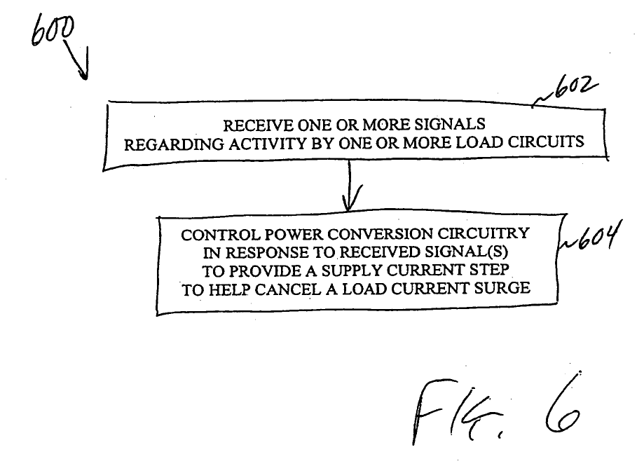

Current surge balance control circuitry 140 for one embodiment may help control power conversion circuitry 130 to provide a supply current step based on activity by load circuit(s) 110 in accordance with a flow diagram 600 of FIG. 6.

For block 602 of FIG. 6, current surge balance control circuitry 140 may receive one or more signals regarding activity by load circuit(s) 110. Such signal(s) may be, for example, indicative of one or more activities that have been performed, are being performed, and/or are to be performed by load circuit(s) 110. Such signal(s) may be, for example, indicative of a count of one or more activities that have been performed, are being performed, and/or are to be performed by load circuit(s) 110. Current surge balance control circuitry 140 for one embodiment may be coupled to receive one or more signals regarding activity by load circuit(s) 110 from load circuit(s) 110. Current surge balance control circuitry 140 for one embodiment may be coupled to receive one or more signals regarding activity by load circuit(s) 110 from other circuitry for load circuit(s) 110.

For block 604, current surge balance control circuitry 140 may help control power conversion circuitry in response to one or more signals received for block 602 to provide a supply current step to help cancel a load current surge. Current surge balance control circuitry 140 for one embodiment may anticipate a load current surge based at least in part on one or more received signals. Current surge balance control circuitry 140 for one embodiment may anticipate, for example, activation of a load circuit. Current surge balance control circuitry 140 for one embodiment may calculate and/or estimate a load current surge based at least in part on one or more received signals. Current surge balance control circuitry 140 for one embodiment may count one or more activities that have been performed, are being performed, and/or are to be performed by load circuit(s) 110 based at least in part on one or more received signals and calculate and/or estimate a load current surge based on least in part on one or more such counts.

Current surge balance control circuitry 140 for one embodiment may repeat operations for blocks 602-604. Current surge balance control circuitry 140 may perform operations for blocks 602-604 in any suitable order and may or may not overlap in time the performance of any suitable operation with any other suitable operation.

Current surge balance control circuitry 140 for one embodiment may comprise, for example, any suitable digital circuitry to help perform operations for flow diagram 600. Current surge balance control circuitry 140 for one embodiment may comprise, for example, control logic, such as a microcontroller for example, to perform instructions to help perform operations for flow diagram 600.

### EXAMPLE SYSTEM

Power control circuitry 120, power conversion circuitry 130, and current surge balance control circuitry 140 may be used to supply power with current surge balance control to any suitable one or more load circuits in any suitable environment.

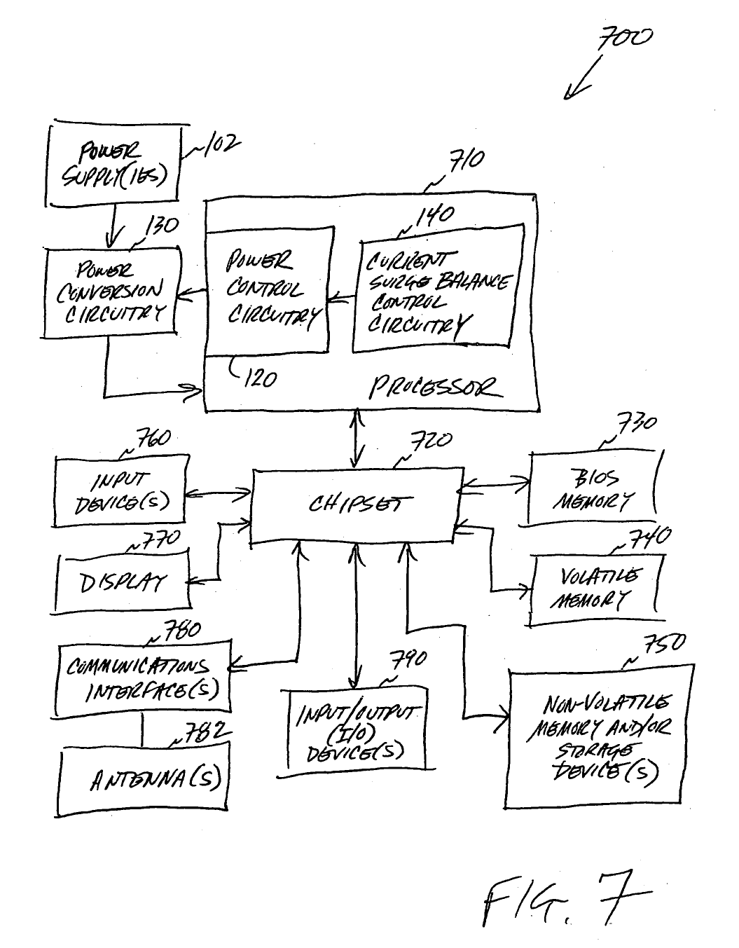

FIG. 7 illustrates an example system 700 including power supply(ies) 102, power conversion circuitry 130, and a processor 710 having power control circuitry 120 to control power conversion circuitry 130 to supply power for processor 710 and having current surge balance control circuitry 140 to help control power conversion circuitry 130 to provide supply current steps by power conversion circuitry 130 to help cancel load current surges. Processor 710 may have any suitable load circuits that may include, for example, one or more processor cores, one or more circuits for cache memory, one or more graphics processing circuits, and/or one or more vector math processing circuits. Such load circuits, power control circuitry 120, and current surge balance control circuitry 140 for one embodiment may be on an integrated circuit for processor 710. Power conversion circuitry 130 for one embodiment may be external to such an integrated circuit.

System 700 for another embodiment may include additional power conversion circuitry to supply power for one or more additional processors one or more of which may similarly have load circuits, power control circuitry 120, and current surge balance control circuitry 140.

System 700 for one embodiment may also include a chipset 720 coupled to processor 710, a basic input/output system (BIOS) memory 730 coupled to chipset 720, volatile memory 740 coupled to chipset 720, non-volatile memory and/or storage device(s) 750 coupled to chipset 720, one or more input devices 760 coupled to chipset 720, a display 770 coupled to chipset 720, one or more communications interfaces 780 coupled to chipset 720, and/or one or more other input/output (I/O) devices 790 coupled to chipset 720.

Chipset 720 for one embodiment may include any suitable interface controllers to provide for any suitable communications link to processor 710 and/or to any suitable device or component in communication with chipset 720.

Chipset 720 for one embodiment may include a firmware controller to provide an interface to BIOS memory 730. BIOS memory 730 may be used to store any suitable system and/or video BIOS software for system 700. BIOS memory 730 may include any suitable non-volatile memory, such as a suitable flash memory for example. BIOS memory 730 for one embodiment may alternatively be included in chipset 720.

Chipset 720 for one embodiment may include one or more memory controllers to provide an interface to volatile memory 740. Volatile memory 740 may be used to load and store data and/or instructions, for example, for system 700. Volatile memory 740 may include any suitable volatile memory, such as suitable dynamic random access memory (DRAM) for example.

Chipset 720 for one embodiment may include a graphics controller to provide an interface to display 770. Display 770 may include any suitable display, such as a cathode ray tube (CRT) or a liquid crystal display (LCD) for example. The graphics controller for one embodiment may alternatively be external to chipset 720.

Chipset 720 for one embodiment may include one or more input/output (I/O) controllers to provide an interface to non-volatile memory and/or storage device(s) 750, input device(s) 760, communications interface(s) 780, and/or I/O devices 790.

Non-volatile memory and/or storage device(s) 750 may be used to store data and/or instructions, for example. Non-volatile memory and/or storage device(s) 750 may include any suitable non-volatile memory, such as flash memory for example, and/or may include any suitable non-volatile storage device(s), such as one or more hard disk drives (HDDs), one or more compact disc (CD) drives, and/or one or more digital versatile disc (DVD) drives for example.

Input device(s) 760 may include any suitable input device(s), such as a keyboard, a mouse, and/or any other suitable cursor control device.

Communications interface(s) 780 may provide an interface for system 700 to communicate over one or more networks and/or with any other suitable device. Communications interface(s) 780 may include any suitable hardware and/or firmware. Communications interface(s) 780 for one embodiment may include, for example, a network adapter, a wireless network adapter, a telephone modem, and/or a wireless modem. For wireless communications, communications interface(s) 780 for one embodiment may use one or more antennas 782.

I/O device(s) 790 may include any suitable I/O device(s) such as, for example, an audio device to help convert sound into corresponding digital signals and/or to help convert digital signals into corresponding sound, a camera, a camcorder, a printer, and/or a scanner.

Although described as residing in chipset 720, one or more controllers of chipset 720 may be integrated with processor 710, allowing processor 710 to communicate with one or more devices or components directly. As one example, one or more memory controllers for one embodiment may be integrated with processor 710, allowing processor 710 to communicate with volatile memory 740 directly.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
modulation circuitry to control power conversion circuitry to supply power for one or more load circuits;
voltage regulation control circuitry to control the modulation circuitry to regulate voltage supply from the power conversion circuitry; and
current surge balance control circuitry to separately control the modulation circuitry to provide supply current steps by the power conversion circuitry to help cancel load current surges.

2. The apparatus of claim 1, wherein the voltage regulation control circuitry is to control the modulation circuitry in accordance with a closed loop control function.

3. The apparatus of claim 1, wherein the modulation circuitry includes a pulse width modulator or a pulse frequency modulator.

4. The apparatus of claim 1, wherein the modulation circuitry is to generate multiple phased control signals over multiple lines to regulate voltage and is to generate supply current step control signals over one or more of the multiple lines to provide supply current steps.

5. The apparatus of claim 1, wherein the modulation circuitry is to extend a pulse width of a phased control signal in response to control by the current surge balance control circuitry to provide a supply current step.

6. The apparatus of claim 1, wherein the current surge balance control circuitry is to monitor load current of the power supply from the power conversion circuitry to help control provision of supply current steps.

7. The apparatus of claim 1, wherein the current surge balance control circuitry is to filter load current of the power supply from the power conversion circuitry to help control provision of supply current steps.

8. The apparatus of claim 7, wherein the current surge balance control circuitry is to bandpass filter load current.

9. The apparatus of claim 1, wherein the current surge balance control circuitry is to accumulate current steps to help control provision of supply current steps.

10. The apparatus of claim 9, wherein the current surge balance control circuitry is to adjust the accumulated current steps for the accumulated current steps to decay over time.

11. The apparatus of claim 9, wherein the current surge balance control circuitry is to update a target voltage for the voltage regulation control circuitry.

12. The apparatus of claim 1, wherein the current surge balance control circuitry is to help control provision of supply current steps based at least in part on a predetermined current step amount.

13. The apparatus of claim 12, wherein the current surge balance control circuitry is to help control provision of a supply current step of the predetermined current step amount.

14. The apparatus of claim 1, wherein the current surge balance control circuitry is to help control provision of supply current steps based at least in part on the difference between a filtered load current and a filtered accumulation of current steps.

15. The apparatus of claim 1, wherein the current surge balance control circuitry is to inhibit provision of a supply current step if voltage supply by the power conversion circuitry exceeds a target voltage.

16. The apparatus of claim 1, wherein the current surge balance control circuitry is to control the modulation circuitry to provide a supply current step in response to one or more signals regarding activity by one or more load circuits.

17. The apparatus of claim 1, wherein the current surge balance control circuitry is to control the modulation circuitry to provide a supply current step in anticipation of a load current surge.

18. The apparatus of claim 1, wherein the current surge balance control circuitry is to control the modulation circuitry to provide a supply current step in anticipation of activation of a load circuit.

19. The apparatus of claim 1, wherein the current surge balance control circuitry is to control the modulation circuitry to provide a supply current step based at least in part on an estimated load current for one or more activities by one or more load circuits.

20. An apparatus comprising:
means for controlling modulation circuitry to regulate voltage supply from power conversion circuitry; and
means for separately controlling the modulation circuitry to provide supply current steps by the power conversion circuitry to help cancel load current surges.

21. The apparatus of claim 20, wherein the means for separately controlling the modulation circuitry to provide supply current steps includes means for monitoring load current of the power supply from the power conversion circuitry.

22. The apparatus of claim 20, wherein the means for separately controlling the modulation circuitry to provide supply current steps includes means for controlling the modulation circuitry to provide supply current steps in response to one or more signals regarding activity by one or more load circuits.

23. A method comprising:
controlling modulation circuitry to regulate voltage supply from power conversion circuitry; and
separately controlling the modulation circuitry to provide supply current steps by the power conversion circuitry to help cancel load current surges.

24. The method of claim 23, wherein the controlling the modulation circuitry to provide supply current steps includes monitoring load current of the power supply from the power conversion circuitry.

25. The method of claim 23, wherein the controlling the modulation circuitry to provide supply current steps includes controlling the modulation circuitry to provide supply current steps in response to one or more signals regarding activity by one or more load circuits.

26. A system comprising:
an alternating current to direct current (AC-DC) converter;
power conversion circuitry to receive power from the AC-DC converter and to supply power; and
a processor coupled to receive power from the power conversion circuitry, the processor having modulation circuitry to control the power conversion circuitry to supply power for the processor, voltage regulation control circuitry to control the modulation circuitry to regulate voltage supply from the power conversion circuitry, and current surge balance control circuitry to separately control the modulation circuitry to provide supply current steps by the power conversion circuitry to help cancel load current surges.

27. The system of claim 26, wherein the current surge balance control circuitry is to monitor load current of the power supply from the power conversion circuitry to help control provision of supply current steps.

28. The system of claim 26, wherein the current surge balance control circuitry is to control the modulation circuitry to provide a supply current step in response to one or more signals regarding activity by one or more load circuits.
